(19) United States
(12) Patent Application Publication
(10) Pub. No.: US 2005/0208984 A1
(43) Pub. Date: Sep. 22, 2005

(54) Unfolding device and mobile phone utilizing the same

(75) Inventor: Shih-Yi Tang, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/079,084

(22) Filed: Mar. 15, 2005

(30) Foreign Application Priority Data
Mar. 22, 2004 (TW) 93107635

(51) Int. Cl. E05D 5/00

(52) U.S. Cl. 455/575.3

(57) ABSTRACT

A mobile phone and an unfolding device applied in the mobile phone. The mobile phone includes a body, an upper housing portion, an actuation assembly, a magnetic device, and a hinge. The upper housing portion is rotatably disposed on the body. The actuation assembly is disposed on the body. The magnetic device is disposed in the body, and coupled to the actuation assembly. The hinge is disposed in the body and the upper housing portion. When the magnetic device generates magnetic force, the upper housing portion is rotated relative to the body to be unfolded by the hinge.

### BACKGROUND

The invention relates to a mobile phone and an unfolding device thereof, and in particular, to a mobile phone that can unfold its upper housing portion by magnetic force.

In foldable mobile phones, upper housing portions are usually unfolded manually. Specifically, after the upper housing portion is manually unfolded to a predetermined angle, it is fully unfolded by a spring in a hinge of the mobile phone.

Recently, hinges for utilizing in mobile phones for automatically unfolding upper housing portions are provided. One type of hinge is semi-automatic. After a button connected to the hinge is pushed, a cam of the semi-auto hinge is separated from another cam thereof. Then, a spring of the hinge provides a force to fully unfold the upper housing portion.

Another type of hinge is electronic. After a button on a body of the mobile phone is pushed, a motor is actuated to drive a gear set, thus unfolding the upper housing portion.

It is very inconvenient to manually unfold the upper housing portion with one hand. Additionally, a certain force is required to push the button connected to the semi-auto hinge. Besides, the semi-auto hinge intends to be longer in length due to the mechanism design. Furthermore, the cost of the electronic hinge is also higher, and generates noises during operation.

### SUMMARY

Accordingly, an embodiment of the invention provides a mobile phone comprising a body, an upper housing portion, an actuation assembly, a magnetic device, and a hinge. The upper housing portion is rotatably disposed on the body. The actuation assembly is disposed on the body. The magnetic device is disposed in the body, and is coupled to the actuation assembly. The hinge is disposed in the body and the upper housing portion. When the magnetic device generates magnetic force, the upper housing portion is rotated relative to the body to be unfolded by the hinge.

Furthermore, the actuation assembly comprises a switch and a button. The switch is coupled to the magnetic device. The button is disposed on the body in a manner such that the button can contact and separate from the switch. The mobile phone further comprises a printed circuit board disposed on the body. The magnetic device and the switch are disposed on the printed circuit board.

It is understood that the magnetic device may comprise a coil.

Additionally, the hinge comprises a first cam, a second cam, a first spring, a housing, a second spring, a shaft, and two E-shaped rings. The first cam is disposed in the body so as to be moved between a first position and a second position. The first cam comprises a rod and a wedge-shaped notch therein. The second cam is disposed in the upper housing portion so as to be rotated between a third position and a fourth position. When the first cam is in the first position, the second cam is in the third position, contacting the first cam. When the first cam rotates to the second position, separating from the second cam by the magnetic force from the magnetic device, the second cam rotates to the fourth position to unfold the upper housing portion. The second cam comprises a second receiving portion, a hollow portion receiving the rod, and a wedge-shaped protrusion contacting the wedge-shaped notch when the first cam is in the second position. The second cam also comprises an inclined surface, facing the housing, in the second receiving portion to abut the end of the first spring. The housing comprises a first receiving portion, and is disposed in the body to receive the first spring. The first spring rotates the second cam to the fourth position from the third position. One end of the first spring enters the first receiving portion when the second cam is in third position. The end enters the second receiving portion when the second cam is in fourth position. The second spring on the first cam returns the first cam to the first position. The shaft passes through the second spring, the first cam, the second cam, the first spring, and the housing. The E-shaped rings are disposed on the shaft and fix the shaft to the housing.

It is noted that only the first cam comprises magnetism, but the second cam does not comprise magnetism.

Moreover, the body comprises a first hole receiving the first cam, and a third hole receiving the housing. The upper housing portion comprises a second hole receiving the second cam.

An unfolding device for an electronic device is also provided. The electronic device comprises a body and an upper housing portion rotatable relative to the body. The unfolding device comprises an actuation assembly, a magnetic device, and a hinge. The actuation assembly is disposed on the body. The magnetic device is disposed in the body, and is coupled to the actuation assembly. The hinge is disposed in the body and the upper housing portion. When the magnetic device generates magnetic force, the upper housing portion is rotated relative to the body and unfolded by the hinge.

### BRIEF DESCRIPTION OF THE DRAWINGS

The invention can be more fully understood by reading the subsequent detailed description and examples with references made to the accompanying drawings, wherein:

FIG. 1a is a schematic view of a mobile phone as disclosed in an embodiment of the invention;

FIGS. 1b-1c are schematic views of the assembled mobile phone in FIG. 1a, wherein FIG. 1b shows the mobile phone in a unfolded position, and FIG. 1c shows the mobile phone in a closed position;

FIG. 2a is an exploded view of a hinge in FIG. 1a;

FIG. 2b is a-cross section of the hinge in FIG. 1a;

FIG. 2c is a schematic view of a first cam and a second cam in FIG. 2a;

FIG. 3 is a schematic view of a hinge and a magnetic device in FIG. 1a;

FIGS. 4a-4d are schematic views of the hinge in different positions; and

FIGS. 5a-5c are schematic views of one end of the spring between a second receiving portion of the second cam and a first receiving portion of the housing.

### DETAILED DESCRIPTION

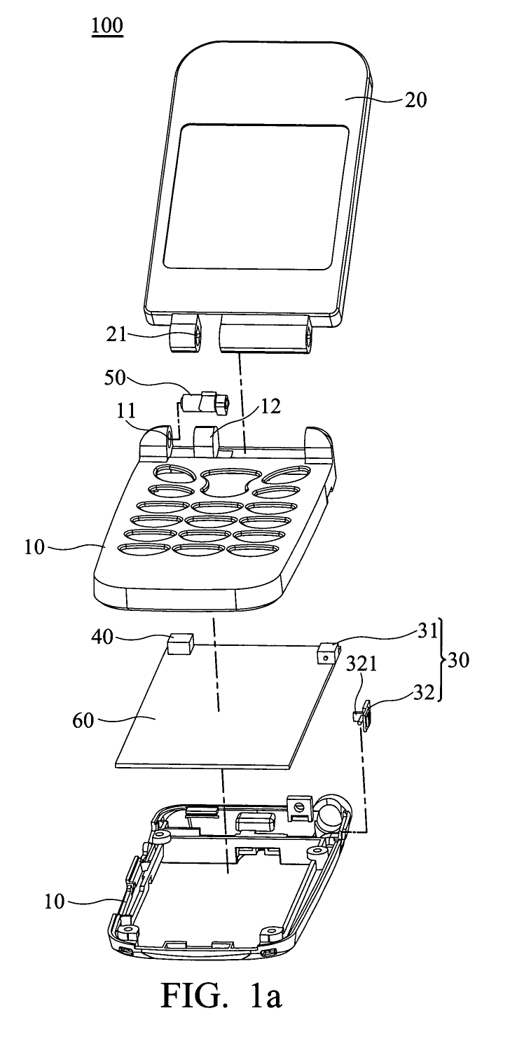

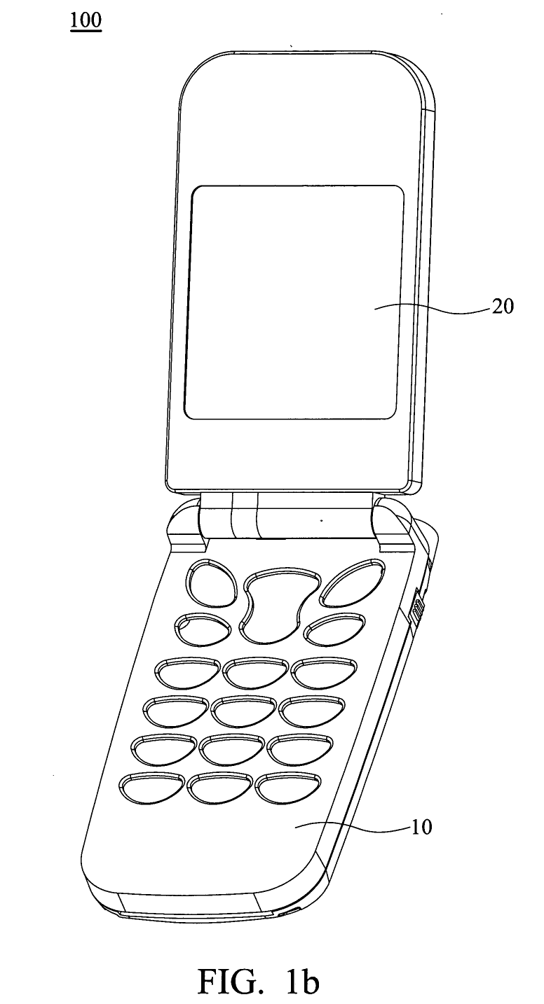

FIGS. 1a-1c are schematic views of a mobile phone 100 as disclosed in an embodiment of the invention. The mobile phone 100 comprises a body 10, an upper housing portion 20, an actuation assembly 30, a magnetic device 40, a hinge 50, and a printed circuit board 60. The actuation assembly 30, the magnetic device 40, and the hinge 50 constitute an unfolding device of an embodiment of the invention.

The body 10 is a basic component of the mobile phone 100, and comprises basic functions required by the mobile phone 100. The body 10 is formed with a first hole 11 and a third hole 12. The upper housing portion 20 comprises a second hole 21, and is rotatably disposed on the body 10.

The actuation assembly 30 comprises a switch 31 and a button 32, and is disposed on the body 10. The switch 31, corresponding to the button 32, is located on the printed circuit board 60, and is coupled to the magnetic device 40. After the button 32 is pressed, the switch 31 is activated to transmit signals. The button 32 is disposed on a side of the body 10 in a manner such that the button 32 can contact and separate from the switch 31. The button 32 comprises a plate 321 actuating the switch 31. That is, in a normal state, the button 32 is separated from the switch 31. To unfold the upper housing portion 20, the button 32 is pushed to contact and actuate the switch 31 via the plate 321. After removing external force, the button 32 and the switch 31 are separated again.

The magnetic device 40 is disposed on the printed circuit board 60 in the body 10, and is located below the hinge 50. When receiving electric current, the magnetic device 40 generates a magnetic field to repulse a first cam 51 of the hinge 50 in an axial direction. It is understood that the magnetic device 40 may be a coil.

The printed circuit board 60 is disposed on the body 10 to process the signals of the mobile phone 100. For example, after the button 32 actuates the switch 31 to transmit signals, the printed circuit board 60 supplies the electric current to the magnetic device 40.

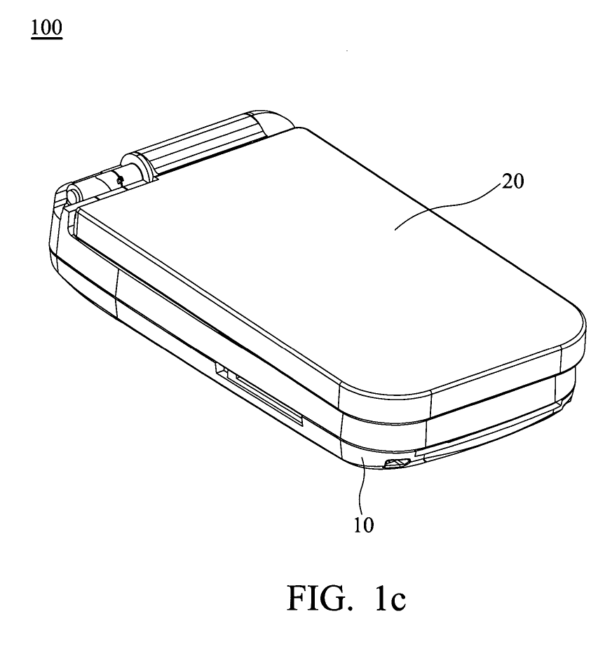

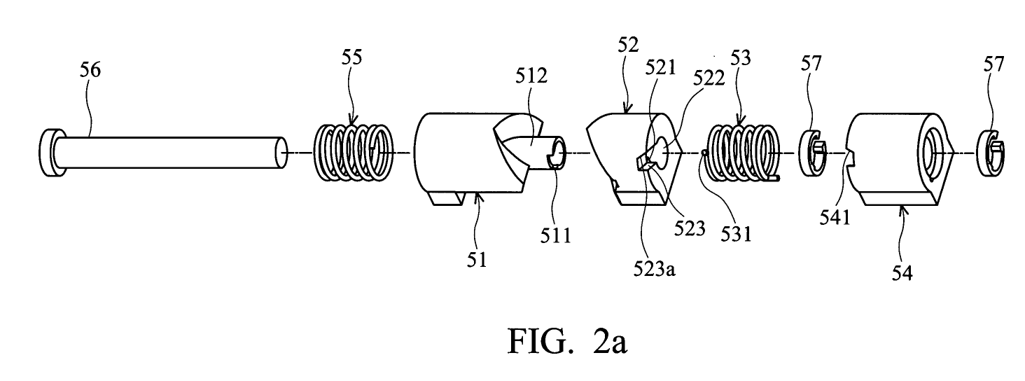

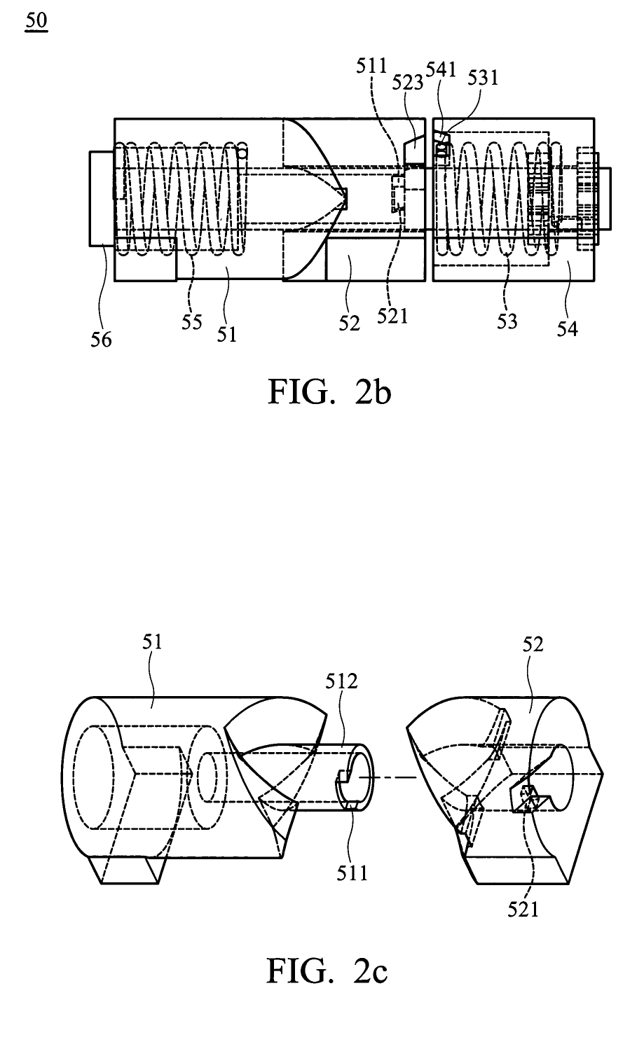

The hinge 50 is disposed in the body 10 and the upper housing portion 20 to provide torsion force for unfolding the upper housing portion 20. That is, when the magnetic device 40 generates magnetic force, the upper housing portion 20 is rotated relative to the body 10 to be unfolded by the hinge 50. Referring to FIGS. 2a-2c, the hinge 50 comprises a first cam 51, a second cam 52, a first spring 53, a housing 54, a second spring 55, a shaft 56, and two E-shaped rings 57.

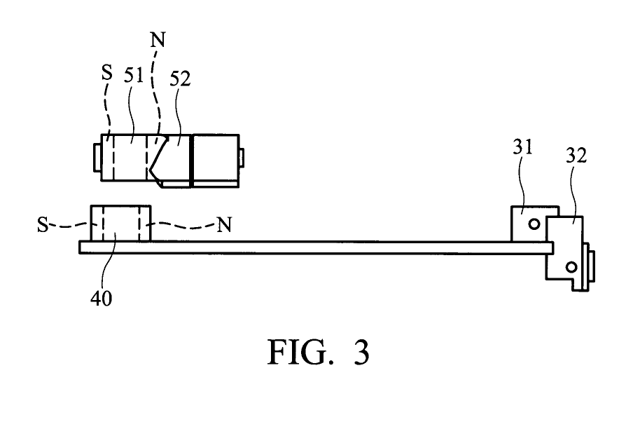

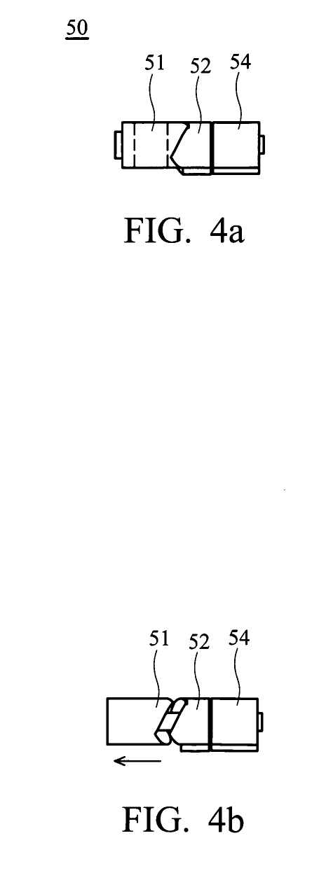

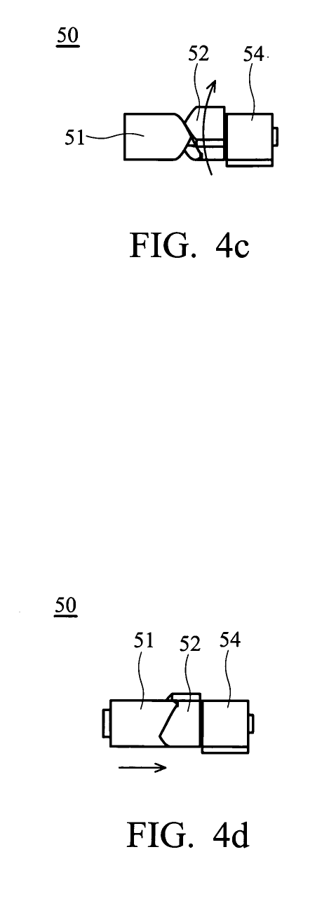

The first cam 51 is disposed in the first hole 11 of the body 10 to be moved between a first position as shown in FIGS. 2b, 3 and 4a and a second position as shown in FIG. 4b. The first cam 51 comprises a rod 512 and a wedge-shaped notch 511 therein as shown in FIG. 2a. Furthermore, it is noted that the first cam 51 is magnetic, with magnetic poles same to those of the magnetic device 40 as shown in FIG. 3. Thus, when the magnetic device 40 generates magnetic force, a repulsive force between the first cam 51 and the magnetic device 40 is generated.

The second cam 52 is disposed in the second hole 21 of the upper housing portion 20 to be rotated between a third position as shown in FIGS. 2b, 3, and 4a and a fourth position as shown in FIG. 4d. The second cam 52 comprises a wedge-shaped protrusion 521, a second receiving portion 523, and a hollow portion 522 receiving the rod 512 of the first cam 51. The second cam 52 also comprises an inclined surface 523a, facing the housing 54, in the second receiving portion 523 to abut an end 531 of the first spring 53. When the upper housing portion 20 is closed, the end 531 of the first spring 53 is impelled to a first receiving portion 541 of the housing 54 by the inclined surface 523a. Additionally, the second cam 52 does not comprise magnetism.

The first spring 53 is disposed in the housing 54 to rotate the second cam 52 to the fourth position from the third position. The housing 54 is disposed in the third hole 12 of body 10, and comprises a first receiving portion 541.

The second spring 55 is located in the first cam 51 to return the first cam 51 to the first position. The shaft 56 passes through the second spring 55, the first cam 51, the second cam 52, the first spring 53, and the housing 54. The E-shaped rings 57 are disposed on the shaft 56 to fix the shaft 56 to the housing 54.

Referring to FIGS. 4a-4d, when the mobile phone 100 is closed as shown in FIG. 1c, the first cam 51 is in the first position, and the second cam 52 is in the third position to closely contact the first cam as shown in FIG. 4a. At this time, the first spring 53 is in a pre-torsion state, and its end 531 is located in the first receiving portion 541 of the housing 54 as shown in FIG. 2b. To unfold the upper housing portion 20, the switch 32 is activated by the button 31, and then transmits a signal to a chip (not shown) on the printed circuit board 60. Then, the printed circuit board 60 supplies the electric current to the magnetic device 40 to generate magnetic field. At this time, the repulsive force between the first cam 51 and the magnetic device 40 is generated so that the first cam 51 moves to the second position to contact the second spring 55 as shown in FIG. 4b. It is noted that the first cam 51 is not rotated relative to the body 10. Then, the second cam 52 is separated from the first cam 51, and the wedge-shaped notch 511 of the first cam 51 contacts the wedge-shaped protrusion 521 of the second cam 52 to slightly rotate the second cam 52 as shown in FIG. 4c. At this time, the end 531 of the first spring 53 moves to the second receiving portion 523 of the second cam 52 from the first receiving portion 541 of the housing 54. Thus, the first spring 53 provides torsion force rotating the second cam 52 to the fourth position as shown in FIG. 4d. As a result, the upper housing portion 20 is unfolded. Additionally, the first cam 51 is returned to closely contact the second cam 52 by the second spring 55.

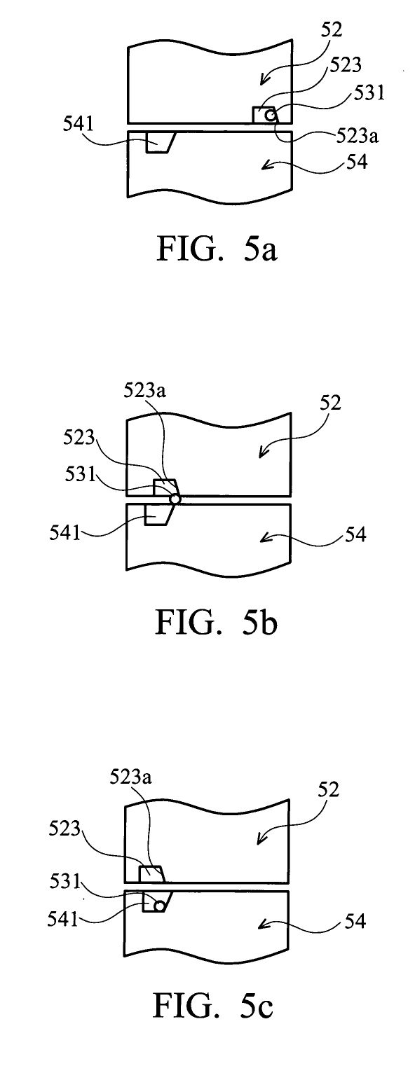

Closing of the upper housing portion 20 is the same as in conventional technology, and detailed description thereof is thus omitted. It is noted that when the second cam 52 is moved to third position as shown in FIG. 4a from the fourth position as shown in FIG. 4d, the end 531 of the first spring 53 is impelled to the first receiving portion 541 of the housing 54 from the second receiving portion 523 of the second cam 52 via the inclined surface 523a of the second receiving portion 523, as shown in FIGS. 5a-5c.

As stated above, the upper housing portion can be easily unfolded by the magnetic force.

It is understood that, while the unfolding device of the embodiment is described in application to a mobile phone, it is not limited thereto, and may be applied in other foldable electronic devices with upper housing portions.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mobile phone comprising:
a body;
an upper housing portion rotatably disposed on the body;
an actuation assembly disposed on the body;
a magnetic device disposed in the body and coupled to the actuation assembly; and
a hinge disposed in the body and the upper housing portion, wherein the upper housing portion is rotated relatively to the body by the hinge to unfold the upper housing portion when the magnetic device generates magnetic force.

2. The mobile phone as claimed in claim 1, wherein the actuation assembly comprises:
a switch coupled to the magnetic device; and
a button disposed on the body in a manner such that the button can contact and separate from the switch.

3. The mobile phone as claimed in claim 2, further comprising a printed circuit board disposed in the body, wherein the magnetic device and the switch are disposed on the printed circuit board.

4. The mobile phone as claimed in claim 1, wherein the magnetic device comprises a coil:

5. The mobile phone as claimed in claim 1, wherein the hinge comprises:
a first cam disposed in the body in a manner such that the first cam can be moved between a first position and a second position; and
a second cam disposed in the upper housing portion in a manner such that the second cam can be rotated between a third position and a fourth position, wherein the second cam is in the third position to contact the first cam when the first cam is in the first position, and the second cam is rotated to the fourth position to unfold the upper housing portion when the first cam is moved to the second position to separate from the second cam by the magnetic force from the magnetic device.

6. The mobile phone as claimed in claim 5, wherein the first cam comprises a wedge-shaped notch, and the second cam comprises a wedge-shaped protrusion contacting the wedge-shaped notch when the first cam is in the second position.

7. The mobile phone as claimed in claim 5, wherein the first cam is magnetic, but the second cam is not magnetic.

8. The mobile phone as claimed in claim 5, wherein the hinge further comprises a first spring rotating the second cam to the fourth position from the third position.

9. The mobile phone as claimed in claim 8, wherein the hinge further comprises a housing disposed in the body to receive the first spring.

10. The mobile phone as claimed in claim 9, wherein the housing comprises a first receiving portion, the second cam comprises a second receiving portion, one end of the first spring is located in the first receiving portion when the second cam is in third position, and the end is located in the second receiving portion when the second cam is in fourth position.

11. The mobile phone as claimed in claim 10, wherein the second cam comprises an inclined surface, facing the housing, in the second receiving portion to abut the end of the first spring.

12. The mobile phone as claimed in claim 9, wherein the hinge further comprises a second spring, located in the first cam, to return the first cam to the first position.

13. The mobile phone as claimed in claim 12, wherein the hinge further comprises a shaft passing through the second spring, the first cam, the second cam, the first spring, and the housing.

14. The mobile phone as claimed in claim 13, wherein the hinge further comprises two E-shaped rings disposed on the shaft to fix the shaft to the housing.

15. An unfolding device for an electronic device, wherein the electronic device comprises a body and an upper housing portion rotatable relatively to the body, and the unfolding device comprises:
an actuation assembly disposed on the body;
a magnetic device disposed in the body and coupled to the actuation assembly; and
a hinge disposed in the body and the upper housing portion, wherein the upper housing portion is rotated relatively to the body by the hinge to be fold the upper housing portion when the magnetic device generates magnetic force.

16. The unfolding device as claimed in claim 15, wherein the actuation assembly comprises:
a switch coupled to the magnetic device; and
a button disposed on the body in a manner such that the button can contact the switch and separate from the switch.

17. The unfolding device as claimed in claim 15, wherein the magnetic device comprises a coil.

18. The unfolding device as claimed in claim 15, wherein the hinge comprises:
a first cam disposed in the body in a manner such that the first cam can be moved between a first position and a second position; and
a second cam disposed in the upper housing portion in a manner such that the second cam can be rotated between a third position and a fourth position, wherein the second cam is in the third position to contact the first cam when the first cam is in the first position, and the second cam is rotated to the fourth position to unfold the upper housing portion when the first cam is moved to the second position to separate from the second cam by the magnetic force from the magnetic device.

19. The unfolding device as claimed in claim 18, wherein the first cam comprises a wedge-shaped notch, and the second cam comprises a wedge-shaped protrusion contacting the wedge-shaped notch when the first cam is in the second position.

20. The unfolding device as claimed in claim 18, wherein the hinge further comprises a first spring rotating the second cam to the fourth position from the third position.

21. The unfolding device as claimed in claim 20, wherein the hinge further comprises a housing disposed in the body receiving the first spring.

22. The unfolding device as claimed in claim 21, wherein the housing comprises a first receiving portion, the second cam comprises a second receiving portion, one end of the first spring is located in the first receiving portion when the second cam is in third position, and the end is located in the second receiving portion when the second cam is in fourth position.
